(19) United States
(12) Patent Application Publication
(10) Pub. No.: US 2011/0247283 A1
(43) Pub. Date: Oct. 13, 2011

(54) REPLACEABLE DOOR JAMB

(76) Inventor: William E. Pagett, Steubenville, OH (US)

(21) Appl. No.: 13/083,654

(22) Filed: Apr. 11, 2011

Related U.S. Application Data
(60) Provisional application No. 61/323,504, filed on Apr. 13, 2010.

(51) Int. Cl. E06B 1/52; E06B 1/04

(52) U.S. Cl. 52/210; 52/213; 52/204.1

(57) ABSTRACT

A door jamb is formed having a vertical jamb member which defines a jamb opening. A replaceable jamb member is sized to be removably secured in the jamb opening by a connection element, preferably shear screws. The shear screws are formed to break or shear apart so as to release the replaceable jamb member when an effective amount of force is applied. When the shear screws break, the replaceable jamb member is free to slide out of jamb opening and release a door which is latched thereto, thus saving the surrounding jamb elements and the door itself from damage. The effective amount of force is generally the force needed to break down a conventional door.

### CROSS-REFERENCE TO RELATED APPLICATION

This application claims priority from U.S. Provisional Application Ser. No. 61/323,504, filed Apr. 13, 2010, the disclosure of which is incorporated herein by reference.

### BACKGROUND OF THE INVENTION

1. Technical Field

The present invention relates generally to door construction. More particularly, the present invention relates to a replaceable door jamb system for a door. Specifically, the present invention relates to a vertical jamb member defining a jamb opening, whereby a replaceable jamb member is removably secured therein by a connection element, and whereby the connection element releases the replaceable jamb member from the jamb opening when an effective amount of force is applied to the door.

2. Background Information

A common way for criminals or law enforcement to gain access to a locked building is to kick or strike an external door so hard that the door lock splits the wood of the door jamb and allows entry into the formerly locked building. This type of forced entry results in physical damage which must be repaired at substantial cost. Not only does physical damage occur in the door jamb, but damage also occurs to the door itself, adding to the complexity and cost of repair. Furthermore, it is commonly known in the art that once a door and door jamb is damaged through forced entry, it rarely provides the same structural integrity and often results in gaps around the periphery of the door. As such, both a damaged door and the door jamb are often entirely replaced, at substantial cost to the owner. When the building is a complex of apartment units located in a high crime area, which is common with public housing, several doors per week may be forced open by either law enforcement or criminals. This results in a dramatic ongoing cost to the building owner which may substantially reduce the return on the real estate investment, or in the case of public housing, cost taxpayers millions every year.

Therefore, there is strong need in the art for an improved doorjamb system which provides the same level of security as a conventional door jamb system, yet prevents substantial damage to the door and door jamb in the event of a forced entry through the door. It is desirable to facilitate a forced entry which preserves the integrity of the door jamb and door by providing a replaceable jamb member which slides out of a vertical jamb member in response to the force. Thus, only the replaceable jamb member requires replacement.

### BRIEF SUMMARY OF THE INVENTION

The present invention relates to a doorjamb having a vertical jamb member defining a jamb opening whereby a replaceable jamb member is removably secured therein by a connection element, preferably in the form of a plurality of shear screws. The shear screws release the replaceable jamb member from the jamb opening when an effective amount of force is applied to a door secured to the door jamb, typically by a criminal or law enforcement forcing entry into a building. The shear screws include an effective force threshold, such that the shear screws purposely break into two portions or shear away threads when the force threshold is reached, to disengage the replaceable jamb member from the vertical jamb member. The effective force threshold is generally equal to the amount of force required to break down a conventional door. Thus, the present invention provides the same amount of protection as a conventional door.

The replaceable jamb member thereafter slides out of the jamb opening, allowing the door to open without splitting or breaking the door jamb. This saves the vertical jamb member and the door itself from damage cause by the forced entry. The building owner or a maintenance person then simply places a new replaceable jamb member in jamb opening and secures it thereto with new shear screws. Replacing the replaceable jamb member and shear screws represents a fraction of the cost of a replacing the entire door jamb or door.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a front elevational view of a building having a door disposed in a wall;

FIG. 2 is a front elevational view of a door frame in a wall having part of the wall cutaway;

FIG. 3 is a front elevational view of the door frame in FIG. 2 having a door disposed in the door frame;

FIG. 4 is an exploded perspective view of the door jamb of the present invention showing the vertical jamb member and replaceable jamb member exploded from the door frame;

FIG. 5 is a side elevational view of FIG. 4;

FIG. 6 is a partially exploded perspective view showing the vertical jamb member secured to the door frame, and the replaceable jamb member, shear screws, weather strip, and interior casing exploded therefrom;

FIG. 7 is a perspective view of the vertical door jamb member secured to the door frame and with the weather strip and interior casing secured thereto;

FIG. 8 is an enlarged cross-sectional view taken along line 8-8 of FIG. 7;

FIG. 9 is an exploded cross-sectional view similar to FIG. 8 after the door is forced open in the direction of Arrow A, and having shear screws with releasable threads;

FIG. 10 is a cross-sectional view similar to FIG. 8 after having the door forced open in the direction of Arrow A, and having shear screws with a breakable shaft; and

FIG. 11 is an exploded perspective view of a second embodiment of the present invention having the vertical jamb member separated into two portions.

Similar numbers refer to similar parts throughout the drawings.

### DETAILED DESCRIPTION OF THE INVENTION

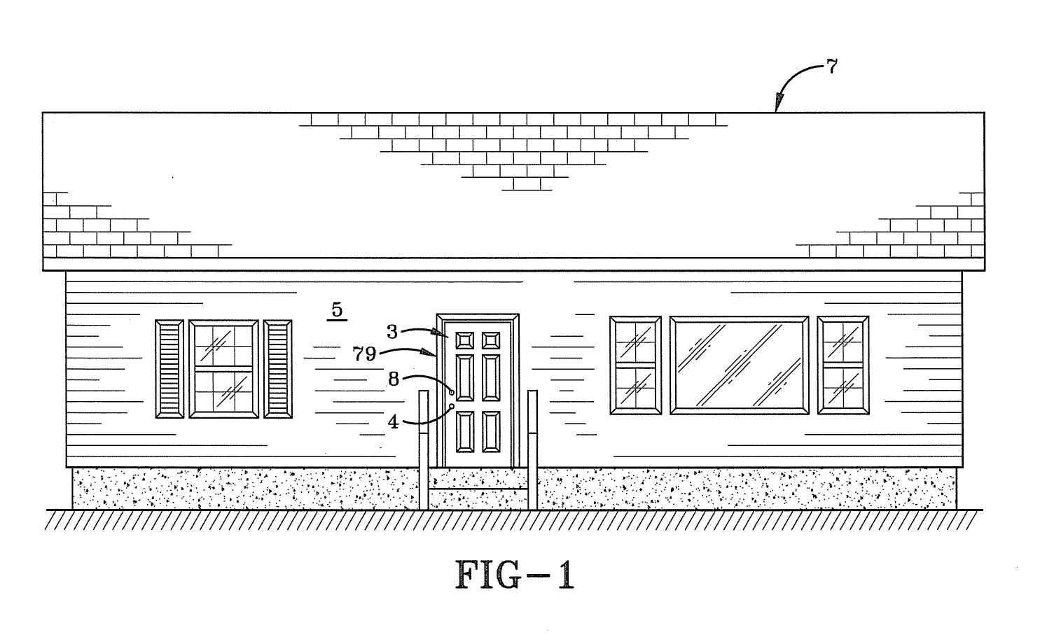

A replaceable door jamb system of the present invention is represented generally at 1, and shown in FIGS. 1-11. As shown particularly in FIGS. 1-3, replaceable door jamb system 1 is incorporated in a door 3 having a door knob 4, a dead bolt latch 8, and hinges 6, which is disposed in a wall 5 of a building 7. Wall 5 is shown in FIG. 1 as an exterior wall of a single-family residential building 7. However, wall 5 of the present invention may be an interior wall and building 7 may be a commercial building, multi-unit, or multi-family structure.

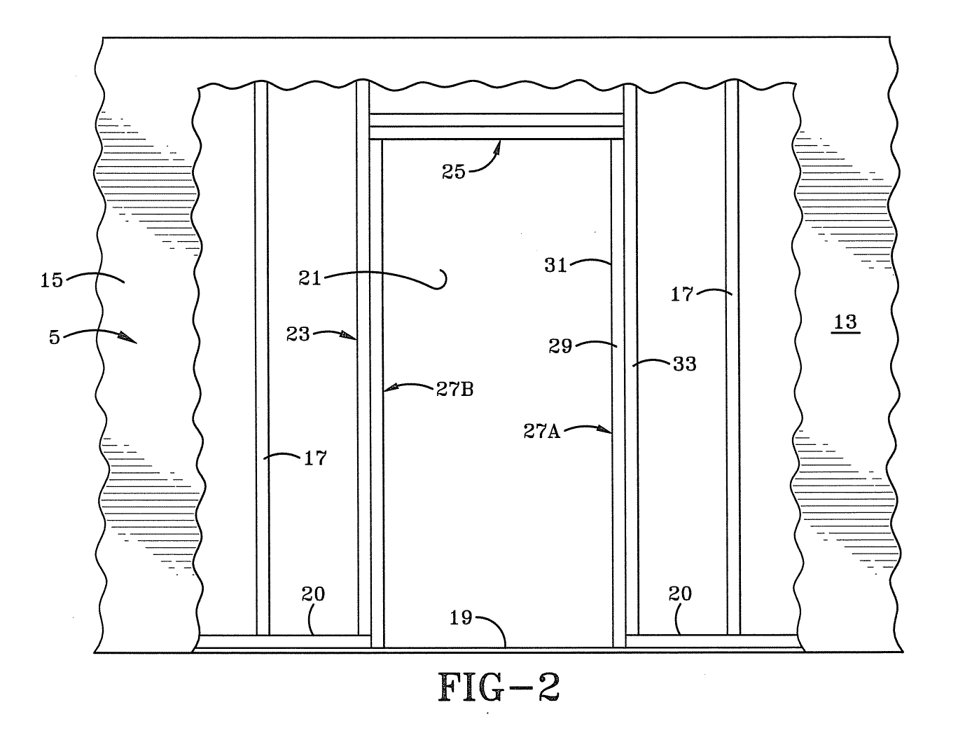

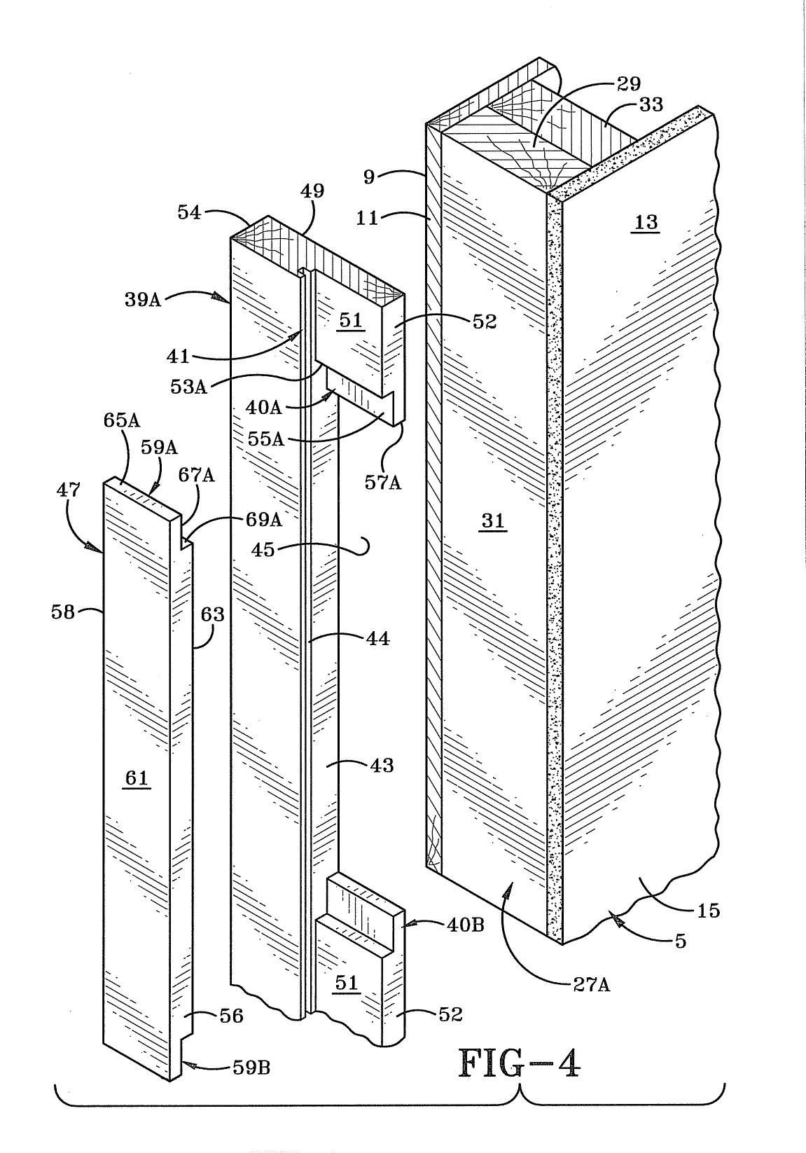

As shown in FIGS. 1-4, wall 3 includes an exterior wall surface 9 formed by a material 11, referred to hereafter as plywood 11. Similarly, wall 3 further includes an interior wall surface 13 formed by a material 15, referred to hereafter as drywall 15. Plywood 11 and drywall 15 are flat plate-like structures disposed in a spaced apart and general vertical direction, extending parallel to one another. As shown in FIG. 2, disposed between plywood 11 and drywall 15 are a plurality of vertical wall studs 17 extending from a floor board 19 and a floor stud 20 to a ceiling (not shown) along the length of wall 3 to provide reinforcement. A door opening 21 in wall 3 is defined by a door frame 23 having a horizontal frame member 25 and a pair of vertical frame members 27A and 27B extending vertically therefrom. As shown in FIG. 4, vertical frame member 27A includes a first stud 29 having an outer face 31 and a second stud 33 adjacent thereto.

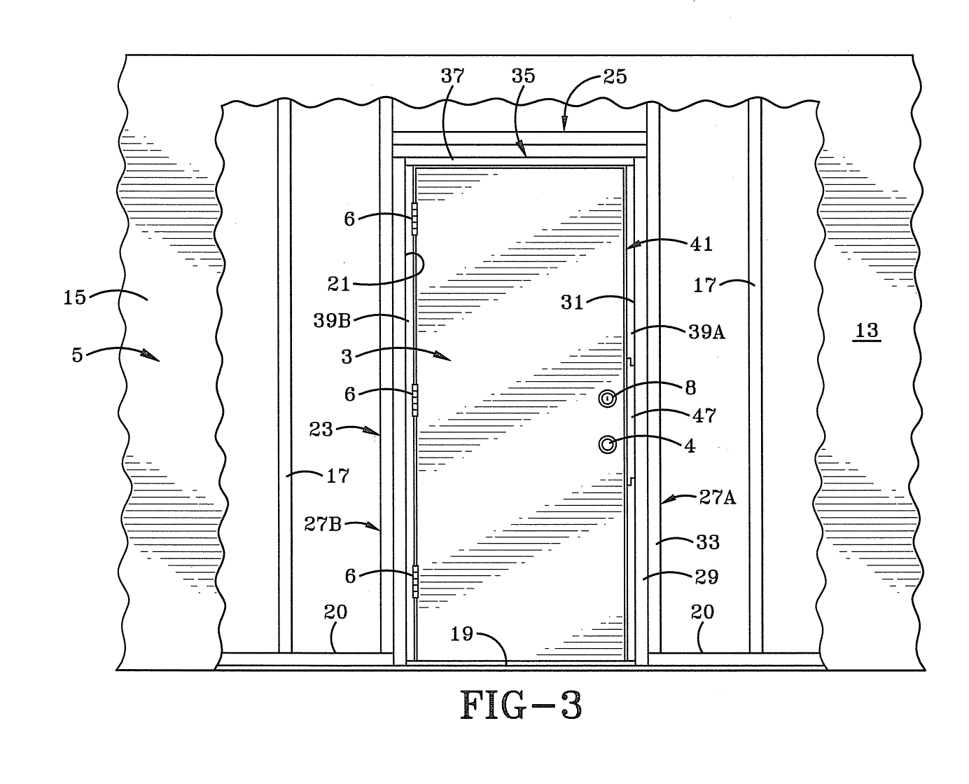

As shown in FIGS. 3 and 4, a door jamb 35 is secured to door frame 23 and includes a horizontal jamb member 37 and a pair of vertical jamb members 39A and 39B extending vertically therefrom. Vertical jamb member 39A includes a pair of projections 40A and 40B, an integrally formed doorstop 41 area, and a side surface 43 having a groove 44 formed therein. Vertical jamb member 39A is formed with a jamb opening 45 and in accordance with the main feature of the invention, includes a replaceable jamb member 47.

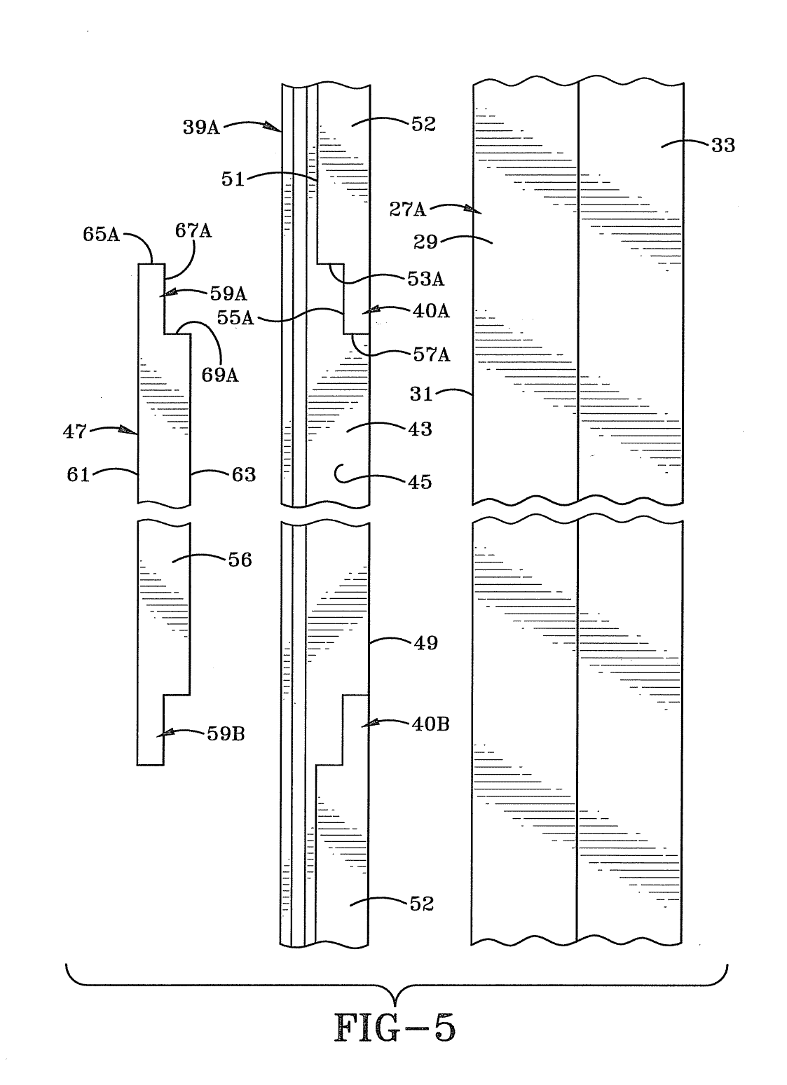

As shown in FIG. 5, vertical jamb member 39A includes a back surface 49, a front surface 51, an interior surface 52, an exterior surface 54, a pair of surfaces 53A and 53B, a pair of surfaces 55A and 55B, and a pair of surfaces 57A and 57B. Replaceable jamb member 47 includes a pair of projections 59A and 59B, a front surface 61, a back surface 63, an interior surface 56, an exterior surface 58, a pair of surfaces 65A and 65B, a pair of surfaces 67A and 67B, and a pair of surfaces 69A and 69B.

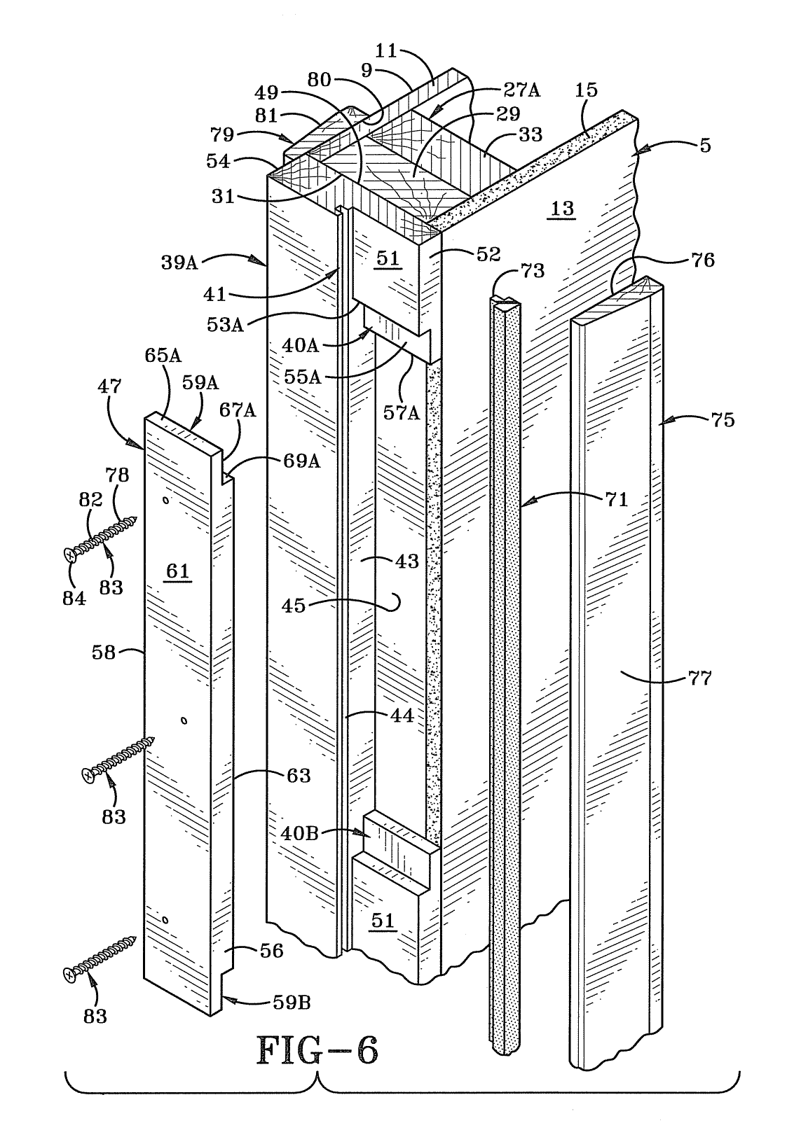

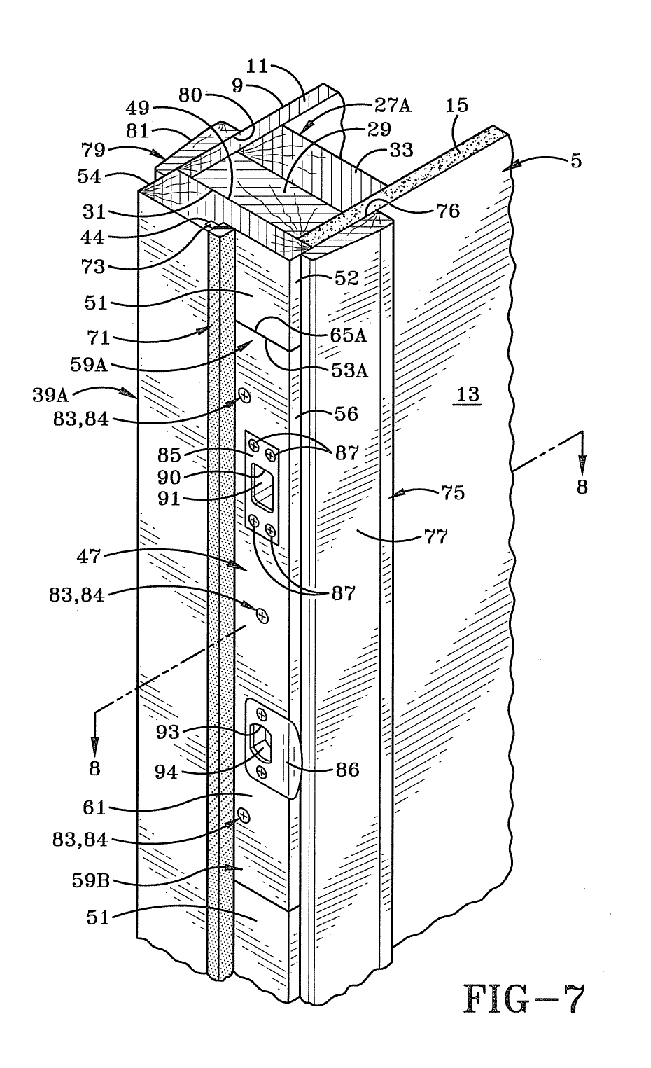

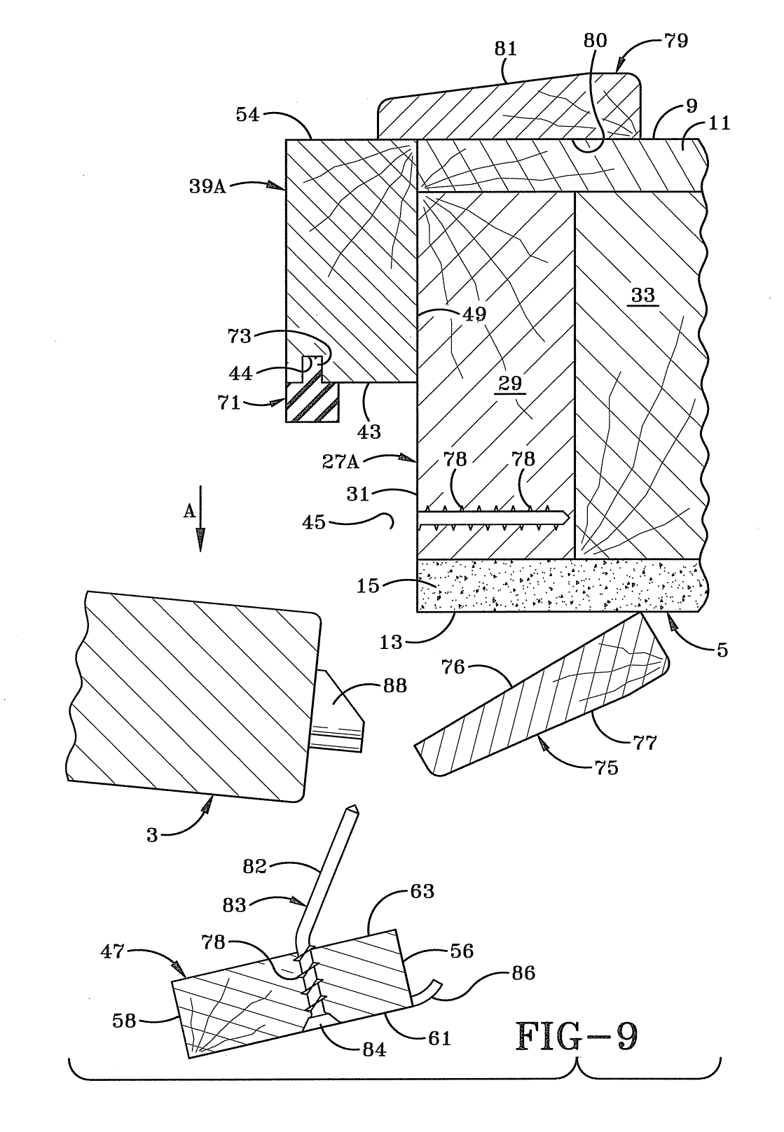

As shown in FIGS. 6 and 7, a weather strip gasket 71 having a projection 73 is fitted into groove 44 in doorstop 41. An interior casing 75 having an inner side 76 and an outer side 77 is secured to wall 3. Similarly, an exterior casing 79 having an inner side 80 and an outer side 81 is secured to wall 3. A plurality of shear screws 83 secure replaceable jamb member 47 in jamb opening 45, wherein a deadbolt strike plate 85 and a knob bolt strike plate 86 are secured by a plurality of screws 87. Each shear screw 83 includes a head 84, a shaft 82, and a plurality of threads 78 disposed on shaft 82. Deadbolt strike plate 85 includes a bolt aperture 90 for passing a deadbolt (not shown) therethrough into a recess 91 formed in removable jamb member 47. Similarly, knob bolt strike plate 86 includes a bolt aperture 93 for passing a knob bolt 88 (FIG. 9) therethrough into a recess 94 formed in removable jamb member 47.

In operation, vertical jamb member 39A is secured to vertical frame member 27A with back surface 49 abutting outer surface 31 and jamb opening 45 is proximate drywall 15. It is common to build and ship an entire door system having a door jamb in a pre-assembled manner, including an attached door. In such a system formed with vertical jamb member 39A, it is desirable to hold replaceable jamb member 47 within jamb opening 45 during transit and installation to add stability to the door system and vertical jamb member 39A in particular as it is moved about. This may be done by any manner common in the art, including staples, heavy duty tape, or any form of an anchor.

As shown in FIG. 6, after vertical jamb member 39A is secured to vertical frame member 27A, replaceable jamb member 47 is secured in jamb opening 45 by extending shear screws 83 through front surface 61 into replaceable jamb member 47, and out of replaceable jamb member 47 through back surface 63. Shear screws 83 then enter first stud 29 through outer surface 31, and securely hold replaceable jamb member 47 in jamb opening 45. Thus, it is a primary feature of the present invention that replaceable jamb member 47 is not secured or connected to vertical jamb member 39A. This configuration facilitates replaceable jamb member 47 moving out of jamb opening 45 without damaging vertical jamb member 39A.

Once replaceable jamb member 47 is secured in jamb opening 45, the user finishes hanging door 3 using typical methods commonly know in the art, which includes drilling recess 91 and recess 94 into replaceable jamb member 47 and securing deadbolt strike plate 85 and knob bolt strike plate 86 thereon. Projection 73 of weather strip gasket 71 is then secured in groove 44, and interior casing 75 and exterior casing 79 are secured to drywall 15 and plywood 11, respectively. When replaceable door jamb system 1 is assembled, door 3 horizontally pivots about hinges 6 whereby door stop area 41 and side surface 43 faces towards the interior of building 7.

As shown in FIGS. 5 and 6, jamb opening 45 is complementarily formed by vertical jamb member 39A such that replaceable jamb member 47 is fittably received in jamb opening 45 by horizontal jamb member 37A. Projections 59A and 59B are shaped to fittably abut projections 40A and 40B, respectively, on vertical jamb member 39A. More particularly, front surface 51 and front surface 61 form a continuous vertical surface along door jamb 35 when replaceable jamb member 47 is secured in jamb opening 45. Surfaces 65A, 67A, and 69A, on replaceable jamb member 47 abut surfaces 53A, 55A, and 57A, on vertical jamb member 39A, respectively. Likewise, surfaces 65B, 67B, and 69B, on replaceable jamb member 47 abut surfaces 53B, 55B, and 57B, on vertical jamb member 39A, respectively.

Door jamb 35 acts as a conventional door jamb when replaceable jamb member 47 is secured in jamb opening 45. However, it is a primary feature of the present invention that when an effective amount of force is applied to door 3, generally directed from the exterior of building 7 towards the interior, replaceable jamb member 47 is released from jamb opening 45. Replaceable jamb member 47 is designed to receive the majority of the force, sliding out of jamb opening 45 to prevent the remaining door elements, in particular vertical jamb member 39A, from incurring damage.

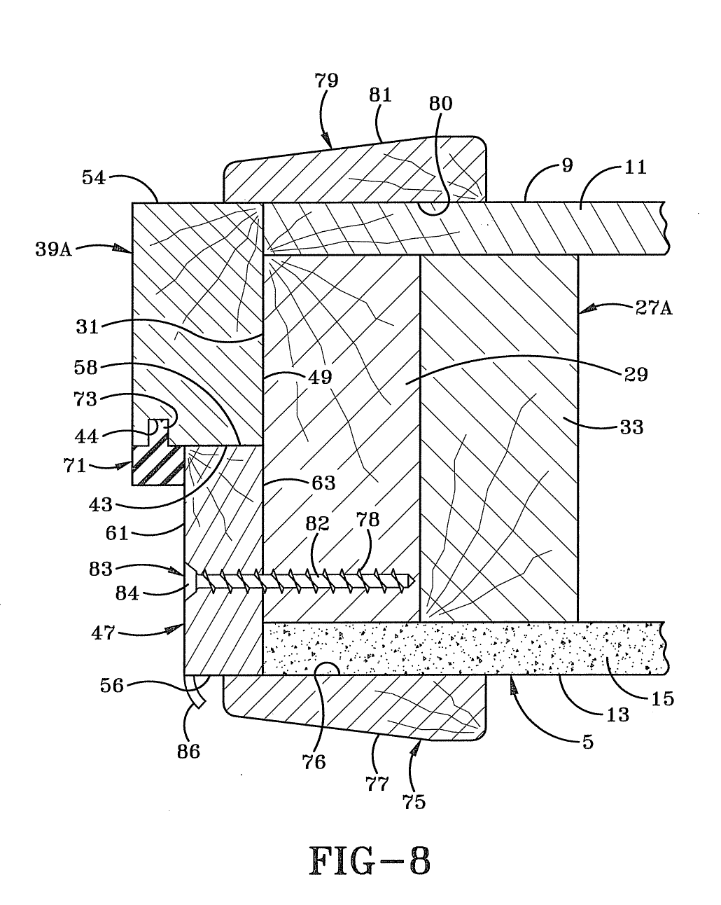

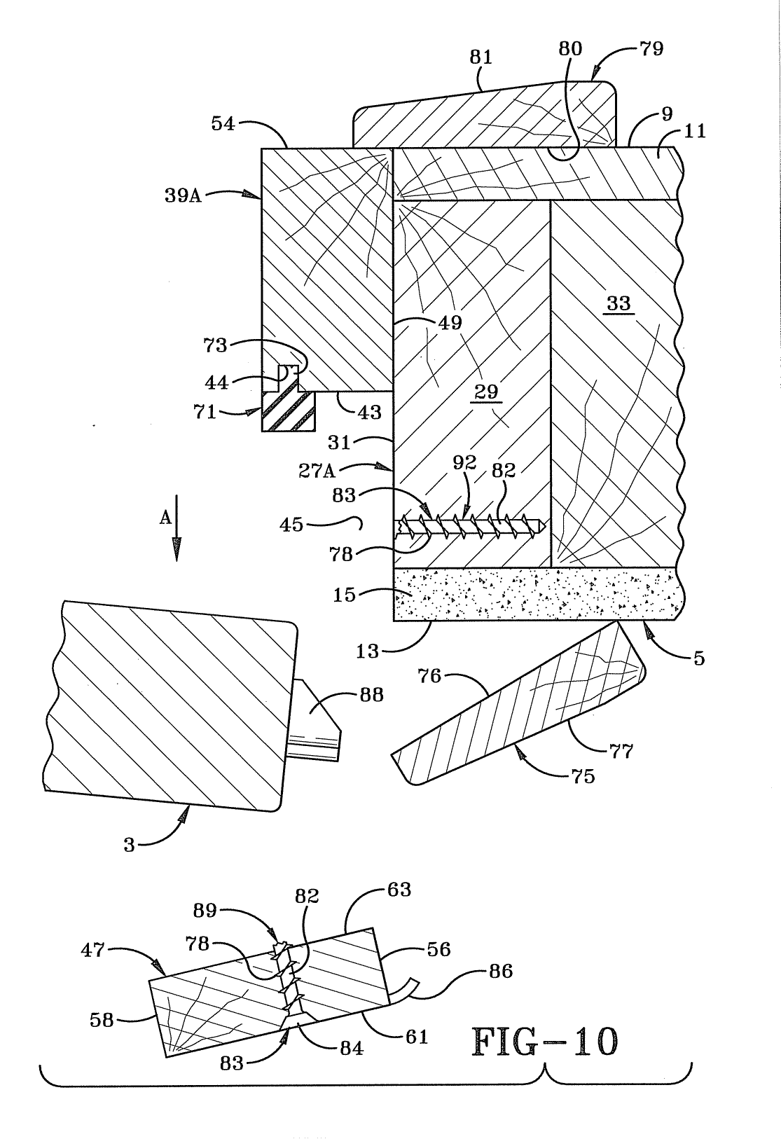

Replaceable jamb member 47 is shown in an attached position in FIG. 8, and is shown in a breakaway position in FIGS. 9 and 10. In the attached position, replaceable jamb member 47 is fittably secured in jamb opening 45, abutting first stud 29 of vertical frame member 27A. Shear screws 83 extend through replaceable jamb member 47 and into first stud 29. Optionally, shear screws 83 may further extend into second stud 33 (not shown). It is well known in the art that force is typically applied from the exterior of building 7 towards the interior, when attempting to break through a locked door. When a force is applied to door 3 from the exterior of building 7 towards the interior in the direction of Arrow A (FIG. 9), the force is transferred through door 3 and knob bolt 88 into replaceable jamb member 47. If the force is sufficient to overcome the resistance strength of shear screws 83, shear screws 83 release replaceable jamb member 47 from first stud 29. As replaceable jamb member 47 is no longer secured to first stud 29, replaceable jamb member 47 slidably moves out of jamb opening 45 in response to the continuing force from knob bolt 88 as door 3 is forced open. Replaceable jamb member 47 thereby slidably moves out of jamb opening 45 and into the breakaway position separated from jamb opening 45 and vertical jamb member 39A, as shown in FIGS. 9 and 10.

As shown in FIG. 9, when a force is applied to door 3 in the direction of Arrow A, knob bolt 88 transfers this force into replaceable jamb member 47, prying replaceable jamb member 47 out of jamb opening 45 in the direction of Arrow A. It is a primary feature of the present invention that shear screws 83 only extend through replaceable jamb member 47 and into first stud 29, and optionally second stud 33. Shear screws 83 do not extend through any part of vertical jamb member 39A. This allows shear screws 83 to break or pull away from first stud 29 without causing damage to vertical jamb member 39A as replaceable jamb member 47 is not secured to vertical jamb member 39A. There exists only a simple surface to surface abutment relationship between replaceable jamb member 47 and vertical jamb member 39A while replaceable jamb member 47 is in jamb opening 45. Surfaces 65A, 65B, 67A, 67B, 69A, and 69B of replaceable jamb member 47 slide along surfaces 53A, 53B, 55A, 55B, 57A, and 57B, respectively, in the direction of Arrow A to allow replaceable jamb member 47 to slide out of jamb opening 45 after shear screws 83 break. Although replaceable jamb member 47 is shown having a general cross-sectional “T” shape, the present invention encompasses a replaceable jamb member having any shape that facilitates the sliding movement required to remove replaceable jamb member 47 from opening 45 without damaging the underlying elements of door jamb 35.

As shown in FIG. 9, replaceable jamb member 47 slides away from vertical jamb member 39A, leaving the surfaces of vertical jamb member 39A generally undamaged. Interior casing 75 is in the path of replaceable door jamb 47 as it moves in the direction of Arrow A. However, it is commonly known in the art to use finishing nails through interior casing 75 to secure interior casing 75 to vertical jamb member 39A and drywall 15 such that when force is applied in the direction of Arrow A to door 3, interior casing 75 is simply knocked off door jamb 35 and may be re-secured thereto when vertical jamb member 39A is replaced. Interior casing 75 is typically undamaged in conventional door jamb systems when the door is broken in, and thus remains so in the present invention.

It is a primary feature of the present invention to use a connection element to releasable secure replaceable jamb member 47 to vertical frame member 27A within jamb opening 45. In the preferred embodiment, this connection element is provided by shear screws 83 to secure replaceable jamb member 47 to vertical frame member 27A. Shear screws 83 are hereby defined as breakable or releasable screws, bolts, or nails, having a particular resistance strength or force threshold, such that when the force threshold is overcome, shear screws 83 release their secure hold on the underlying element. One skilled in the art would immediately recognize that the force threshold in shear screws 83 should be generally equal to the resistance strength of a conventional door jamb system to provide a similar level of security. For example, if a conventional door jamb system requires at least one-hundred pounds per square inch of force on the door to break and splinter the doorjamb, thus opening the door, shear screws 83 would similarly require at least one-hundred pounds per square inch of force on door 3 to break shear screws 83 and release replaceable jamb member 47 from jamb opening 45. An effective amount of force is hereby defined as the amount of force necessary to break down a conventional door generally formed having the same type of door jamb. Therefore, the effective force threshold of the shear screws is reached generally when a conventional door would splinter and give way, allowing entry into the building.

Shear screws 83 are shown in FIG. 9 shedding threads 78 when the effective force threshold is overcome. Threads 78 are secured to shaft 82 such that when a force having a sufficient magnitude is applied to shear screw 83, threads 78 shear off shaft 82, thereby allowing shaft 82 to slidingly disengage with first stud 29. Similarly, shear screws 83 are shown in FIG. 10 breaking into a first portion 89 and a second portion 92 when the force threshold is overcome. Although shear screws 83 are shown in FIGS. 9 and 10 as having shedable threads or breakable portions, any method or mechanical element that facilitates releasing the secure connection between replaceable jamb member 47 and vertical frame member 27A in response to the desired force threshold being overcome is encompassed by the present invention, including nails, bolts, or adhesive.

As described above, shear screws 83 release replaceable jamb member 47 from jamb opening 45 and vertical frame member 27A only when the desired force threshold is overcome. As such, replaceable door jamb system 1 provides the same level of security as conventional door systems. However, the time and financial cost of replacing a broken door is dramatically reduced. A maintenance person may keep multiple replacement jamb members 47 on hand, and even pre-drill the holes for deadbolt strike plate 85 and knob bolt strike plate 86. When a door is broken, the old replaceable jamb member 47 and shear screws 83 are discarded, and a new replaceable jamb member 47 is simply inserted into jamb opening 45 and secured with a new set of shear screws 83.

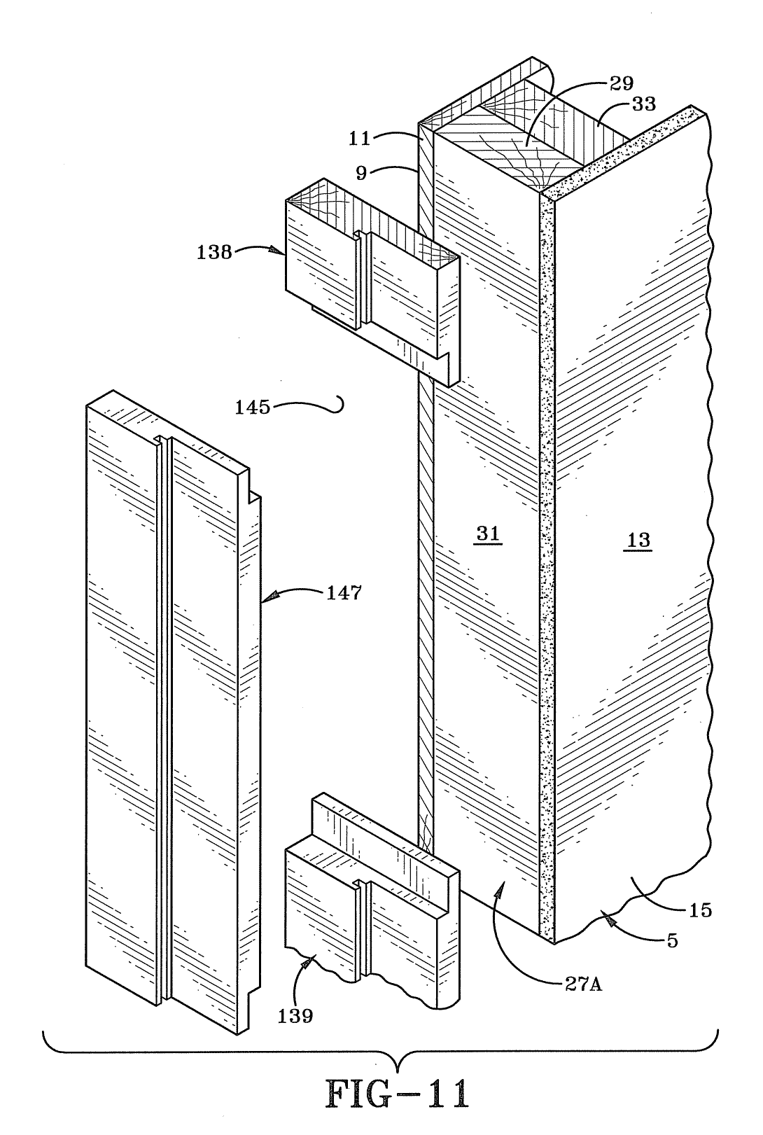

Vertical jamb member 39 and replaceable jamb member 47 may be formed having any complementary shapes that facilitate the break-away novel aspect of replaceable door jamb system 1 as described herein above. As shown in FIG. 11, a second embodiment of the invention, namely a replaceable jamb system 101, includes a vertical jamb member 39A comprising two separate pieces, namely, a portion 138 and a portion 139, wherein a jamb opening 145 extends entirely between portion 138 and portion 139. A replaceable jamb member 147 is shaped to be fittably inserted into jamb opening 145. In replaceable jamb member 147, side surface 43 is eliminated and surfaces 53, 55, and 57 extend fully to exterior surface 54, thus jamb opening 145 is extended entirely through vertical jamb member 39A. As discussed previously in the preferred embodiment, replaceable jamb member 147 moves out of jamb member 39A in response to an effective amount of force on door 3.

It is also within the scope of replaceable door jamb system 1 that replaceable jamb member 47 may extend the entire vertical length of door frame 23, generally from floor board 19 to horizontal frame member 25. As such, it is a feature of the replaceable door jamb system 1 that replaceable jamb member 47 may be formed in any vertical length which fits within door opening 21. Furthermore, as discussed above with respect to replaceable jamb system 101, replaceable jamb member 147 may be formed in any horizontal width which fits within door opening 21. As such, any feasible length and width of forming a replaceable jamb member is encompassed by the present invention.

Replaceable door jamb system 1 is universally adaptable for use with substantially any door frame or door system, as replaceable jamb member 47 may receive any size or type of bolts or strike plates. The installer simply installs any locks, deadbolts, and plates which are desired or required by the door system, and thereby subsequently drills shear screws 83 through any unobstructed portion of replaceable jamb member 47 into first stud 29. This allows the installer to customize replaceable door jamb system 1 for any door frame or system.

Furthermore, the present invention encompasses retrofitting an existing door jamb to include replaceable jamb member 47. To accomplish this, a building owner may simply cut out a replaceable jamb member from a standard vertical jamb member and then secure it through the door frame with shear screws 83 or any connection element encompassed by the present invention. To form a replaceable jamb member out of an existing vertical jamb member, a vertical cut may be applied along the door backstop area and intersected with two horizontal cuts, such that a replaceable jamb member and jamb opening is formed.

Replacing replaceable jamb member 47 and a connection element such as shear screws 83 represent a fraction of the time and money cost of replacing an entire splinted door 3 or vertical jamb member 39. Unlike conventional door systems, door 3 and vertical jamb member 39 are not splinted or broken by the breaking forces applied to door 3. Thus, replaceable jamb member 47 is a sacrificial part, an analogue of the electric fuse, which prevents the more expensive and difficult to replace parts of replaceable door jamb system 1 from being damaged.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A door jamb adapted to fit into a door frame, said door jamb comprising:
a vertical jamb member defining a jamb opening;
a replaceable jamb member sized to fit into the jamb opening; and
wherein the replaceable jamb member is removably secured in the jamb opening.

2. The door jamb of claim 1, wherein the replaceable jamb member is not secured to the vertical jamb member.

3. The door jamb of claim 1, wherein the replaceable jamb member is removably secured in the jamb opening by at least one fastener.

4. The door jamb of claim 3, wherein the at least one fastener extends through the replaceable jamb member and into the door frame to removably secure the replaceable jamb member thereto.

5. The door jamb of claim 3, wherein the at least one fastener is a shear screw having an effective shear threshold, and wherein the shear screw is configured to release replaceable jamb member from the jamb opening when when a force greater than the effective shear threshold is applied to the door jamb.

6. The door jamb of claim 5, wherein the replaceable jamb member is not secured to the vertical jamb member.

7. The door jamb of claim 6, further comprising a door stop surface disposed on the vertical jamb member, and wherein the replaceable jamb member abuts the door stop surface when the replaceable jamb member is secured in the jamb opening.

8. The door jamb of claim 1, further comprising a breakaway threshold, wherein the replaceable jamb member is released from the jamb opening when a force greater than the breakaway threshold is applied to the door jamb.

9. The door jamb member of claim 1, wherein the vertical jamb member is comprised of a first jamb member and a spaced apart and separate second jamb member, and wherein the jamb opening is defined therebetween.

10. A door jamb adapted to fit into a door frame, said door jamb comprising:
a vertical jamb member having a surface which define a jamb opening;
a replaceable jamb member sized to abut the surface when the replaceable jamb member is disposed in the jamb opening;
a connection element for securing the replaceable jamb member in the jamb opening, wherein the connection element releases the releasable jamb member from jamb opening when an effective amount of force is applied to the door jamb.

11. The door jamb of claim 10, wherein the replaceable jamb member is not secured to the vertical jamb member.

12. The door jamb of claim 10, wherein the connection element is at least one fastener.

13. The doorjamb of claim 12, wherein the at least one fastener extends through the replaceable jamb member and into the door frame to removably secure the replaceable jamb member thereto.

14. The door jamb of claim 10, wherein the connection element is at least one shear screw, and wherein the at least one shear screw breaks to release the replaceable jamb member from the jamb opening when the effective amount of force is applied to the door jamb.

15. The door jamb of claim 14, wherein the replaceable jamb member is not secured to the vertical jamb member.

16. The door jamb of claim 15, wherein the replaceable jamb member includes a strike plate secured thereto.

17. In an entryway having an opening defined by spaced vertically extending vertical frame members, a header spanning the tops of the vertical frame members, a hinged door closable within the opening and having an outside face, and weather strips extending along the framing members for sealing against the outside face of the door when closed, the improvement wherein said one of the vertical frame members defines a jamb opening therein sized to receive a first replaceable jamb member, said first replaceable jamb member being releasably secured within the jamb opening by a connection element having a releasing threshold, whereby the connection element releases the first replaceable jamb member from the jamb opening when the releasing threshold is forcibly surpassed.

18. The entryway of claim 17, wherein the connection element comprises at least one shear screw.

19. The entryway of claim 17, further comprising:
a dead bolt strike plate secured to the first replaceable jamb member; and
a knob bolt strike plate secured to the first replaceable jamb member.

20. The entryway of claim 17, further comprising a second replaceable jamb member for use in replacing first replaceable jamb member when the connection element releases the first replaceable jamb member from the jamb opening.
